(19) United States
(12) Patent Application Publication
(10) Pub. No.: US 2017/0140388 A1
(43) Pub. Date: May 18, 2017

(54) METHOD AND APPARATUS FOR MANAGING JURISDICTIONALLY REGULATED CANNABIS

(71) Applicants: John Thorne, Salt Lake City, UT (US); Mitchell Day, Denver, CO (US)

(72) Inventors: John Thorne, Salt Lake City, UT (US); Mitchell Day, Denver, CO (US)

(73) Assignees: Mitchell Day, Denver, CO (US); John Thorne, Salt Lake City, UT (US)

(21) Appl. No.: 14/942,941

(22) Filed: Nov. 16, 2015

(51) Int. Cl. G06Q 30/00; G06F 17/30; G06Q 50/18

(52) U.S. Cl. CPC G06Q 30/018; G06Q 50/18; G06F 17/3087; G06F 17/30598

(57) ABSTRACT

Embodiments of the present invention provide a genetic testing system that facilitates the management of various regulated plant products, for example regulated cannabis, and enables the relation of regulatory jurisdiction to the regulated plant originating from the regulatory jurisdiction. Numerous advantages are described herein for example associating genotype to phenotype for crop improvement, enablement of intellectual property mechanisms in a new industry, and protecting the consumer by ensuring that an identifier for a particular regulated plant correlates to a specific genotype with a known chemical profile and any associated quality control/quality assurance documentation.

### CROSS REFERENCES TO RELATED APPLICATIONS

This application claims the benefit of and is a non-provisional of U.S. Provisional Application Ser. No. 62/080,138 filed on Nov. 14, 2014, which is expressly incorporated by reference in its entirety for all purposes as if fully set forth herein.

### TECHNICAL FIELD

The present disclosure relates generally to the management of a jurisdictionally regulated plant. More specifically a management method comprising genetic identification to manage, track, or identify cannabis or other commercial plants that are regulated under a plurality of regulatory or geographic jurisdictions.

### BACKGROUND

The present invention relates to the creation of a genetic database composed of multiple data types from disparate sources with multiple applications to the cannabis industry. The described method is a novel innovation that will result in a universal database that houses a multitude of potential applications towards legitimizing, regulating, harnessing the benefits and ameliorating the harms of an emerging industry. The database described is considered central due to the fact that it can be used at all points in the supply chain and is capable of assimilating existing database content from multiple sources.

### BRIEF DESCRIPTION OF THE DRAWINGS

FIG. 1 is exemplar schematic of a method for a management of a regulated plant using the system of FIG. 6.

FIG. 2 is a schematic of an exemplar method for identifying an unknown regulated plant using the system of FIG. 6.

FIG. 3 is a schematic of an exemplar method for branding a regulated plant using the system of FIG. 7.

FIG. 4 is a schematic of an exemplar method for identifying brand misappropriation of a regulated plant using the system of FIG. 6.

FIG. 5 is an exemplar table used for storing data associated with a regulated plant in the system of FIG. 6.

FIG. 6 is a schematic of an exemplar system for managing a regulated plant.

FIG. 7 is a schematic of an exemplar method of managing variations of a regulated plant using the system in FIG. 6.

FIG. 8 is a schematic of an exemplar method for identifying variants based on genetic data using the system of FIG. 6.

FIG. 9 is a schematic of an n exemplar method for identifying genetic data associated with a variant using the system of FIG. 6.

FIG. 10 is a schematic of an exemplar method for identifying a regulated plant based on genetic data using the system of FIG. 6.

FIG. 11 is a schematic of an exemplar method of identifying a jurisdiction of a regulated plant using the system of FIG. 6.

FIG. 12 is exemplar block diagram of attributes used in managing regulated plants using the system of FIG. 6.

FIG. 13 is an exemplar report generator for managing a regulated plant using the system of FIG. 6.

FIG. 14 is an exemplar block diagram of storing a plurality of regulated plants using the system in FIG. 6.

FIG. 15 is an exemplar block diagram of storing regulated plan variants in the system of FIG. 6.

### DETAILED DESCRIPTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The present invention will now be described more fully hereinafter with reference to the accompanying drawings, in which preferred embodiments of the invention are shown. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention is preferably written in an object oriented programming language such as Java®, Smalltalk or C++. However, the computer program code for carrying out operations of the present invention may also be written in conventional procedural programming languages, such as the “C” programming language. The program code may execute entirely on the user's computer, as a stand-alone software package, or it may execute partly on the user's computer and partly on a remote computer. In the latter scenario, the remote computer may be connected to the user's computer through a LAN or a WAN, or the connection may be made to an external computer (for example, through the Internet using an Internet Service Provider).

The present invention is described below with reference to flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

It is to be understood that the present invention may be utilized in conjunction with statutes, laws, and regulations relating to any type of regulated activity. The present invention is not limited to the regulated activity of cannabis regulation. The term “legal jurisdiction” shall be understood to include all types of geographically-delineated areas of authority, including, but not limited to, countries, states, counties, and municipalities; including also a “franchise jurisdiction,” a specific form of legal jurisdiction that could be held as a form of property called a franchise. Traditional franchise jurisdictions of various powers were held by municipal corporations, religious houses, guilds, early universities, and other regulating bodies. For example, a “regulated entity” is a distinct location, or an individual or organization operating without a fixed location that is subject to regulations constraining its behavior. In some regulatory settings, a different terms are is used for specific requirements defining conditions of operation-stating documents, including “license,” “authorization,” or “approval”. All of these terms and meanings are covered by this disclosure and any that may be the equivalent of the terms and meanings discussed.

The following are specifically preferred embodiments of the present invention. For example, they refer to preferred ways of managing a regulated plant across a plurality of jurisdictions and the various applications to branding, tracking, trait identification and prediction, and distributor location and origination.

The elements of the described invention may store instructions to map genetic identifier data of a regulated plant product to that of other data and distributor data stored in a distributor database for a first cannabis sample that may then be accessed for subsequent query by an external party.

The elements of this disclosure have been designed to incorporate and store a plurality of regulated plant samples and corresponding sample data. Referring to a sample as a “first sample” or a “second sample” should be considered arbitrary and is intended only for clarity of describing how elements of the disclosure are designed to handle numerous samples and their associated data in parallel.

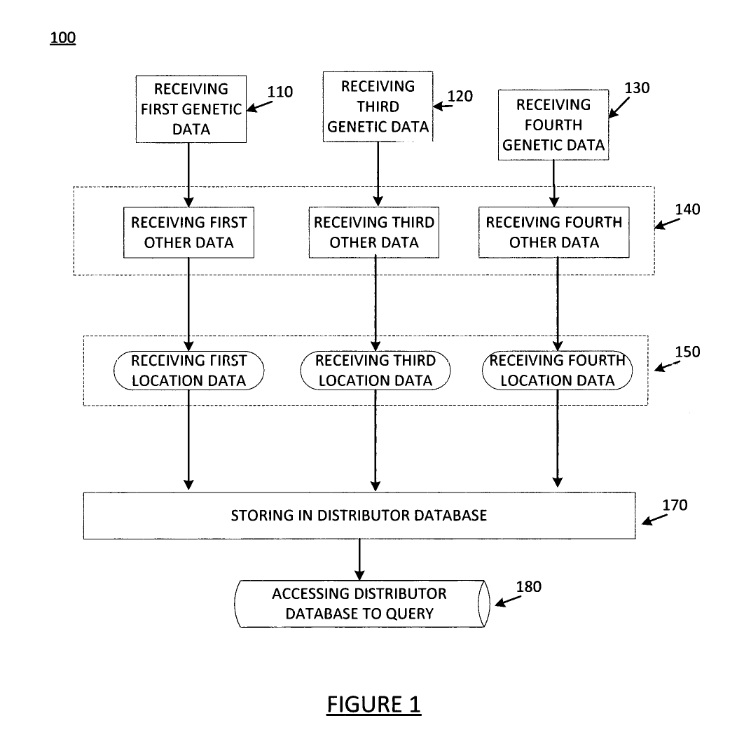

The aforementioned elements are highlighted in a schematic in FIG. 1, an exemplar method for the management of a regulated plant product. Method 100 is an embodiment meant to indicate how a first regulated plant sample is to be correlated with genetic data 110 other data 140 and location data 150. In other embodiments a plurality of genetic data (110, 120, and 130) may be received, along with a plurality of corresponding other data 140 and location data 150 associated with the respective distributors of the samples wherein the genetic data 110, 120, and 130 were derived. The plurality of genetic data 110, 120, and 130; the plurality of other data 140; and the plurality of location data may all be deposited into the Distributor Database 170.

Method 100 relates the disclosure's ability to store a sample's genetic data 110, 120, and 130; and then provide a method that allows a query to be run on the stored genetic data 110, 120, and 130. Distributor database 170 may be comprised of a single data base wherein all data is stored, or distributor database 170 may be an array or collection of databases that are all communicatively connected. In the latter the queries may be run across all the databases that make up the distributor database 170 in the same manner as if the distributor database 170 was a single database.

Referring to FIG. 1, elements of an exemplar method for retaining and relating genetic data from a first cannabis sample 110 to that of first other data 140 and location data 150 into a distributor database 170. The schematic of FIG. 1 has been constructed to reflect the incorporation of many samples and their associated data into a distributor database 170 for future query. The query may be made by a host of parameters and is largely confined to the types of data deemed necessary by the needs of the user making the inquiry within the database.

First other data 140 may be, but not limited to, genetic expression profiling, geographical qualification, jurisdiction of origin, producer of origin, method of manufacture, agricultural treatment(s), quality control metrics batch/lot number, microbial counts etc. The utility of the described invention is to relate the aforementioned data types for a plurality of regulated plant samples with a genetic code and method 100 in FIG. 1 depicts the handling of multiple samples (120 and 130) by a similar workflow for a single regulated plant sample.

The ability to query the distributor database 170 is of intrinsic necessity to method 100, as the data identifiers associated with a sample's genetic data 110, 120, and/or 130 may be of interest to various industrial and commercial needs. For example, as the distributor database 170 grows, it will be of great need to relate newly entered samples to samples already present in the database. Relation of newly entered samples to preexisting samples in the distributor database 170 may be achieved by adjusting query parameters to the data type of interest. The data type may be the sample genetic data 110, 120, and/or 130, other data 140 and/or location data 150. The query search may return one or more matches based on query parameters.

The significance of relating genetic data 110, 120, and/or 130, other data 140 and location data 150 into a singular, query-executable, and distributor database 170 can be demonstrated by that of a producer or jurisdictionally mandated regulated plant recall. The search of a regulated plant product by associated genetic data to the many points of sale through the distributor database 170 is crucial for implementing any type of mandated recall. FIG. 1 depicts how a plurality of regulatory plant samples are stored and accessible for future query.

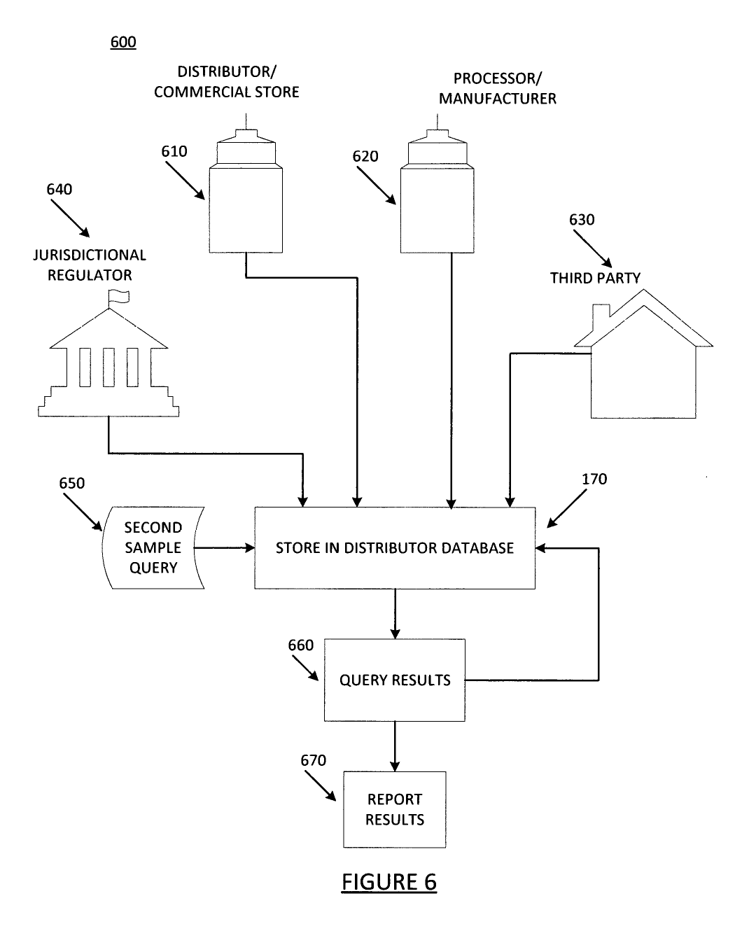

For example, turning briefly to FIG. 6, an exemplar embodiment of a system for a regulated plant network 600 across jurisdictions, wherein the current disclosure may apply, is schematically represented. The regulated plant may be any consumable plant that has a genetic code: for example maze, soy, potatoes or cannabis. Additionally the regulated plant may be regulated by a plurality of jurisdictions for the application, distribution, funding, supplying, testing, trading, or consuming. System 600 of FIG. 6 is an exemplar representation of such network. We will return to FIG. 6 in more detail below.

The complex legislative and legal landscape of cannabis and other regulated plant industries will benefit from the current disclosure's capacity to associate location data with that of the jurisdiction of origin and/or receipt. The ability to associate jurisdictional regulations, on a sample will alleviate some of immediate difficulties present in a new industry with varying regional legality and regulatory requirements. Furthermore, the distributor location and jurisdictional location of the distributor may be correlated, allowing the efficient and legal transfer of regulated products throughout the supply chain. The disclosure's capacity to create and store this corollary jurisdictional data with a genetic fingerprint will grant a level of regulatory control not previously or currently found in the industry.

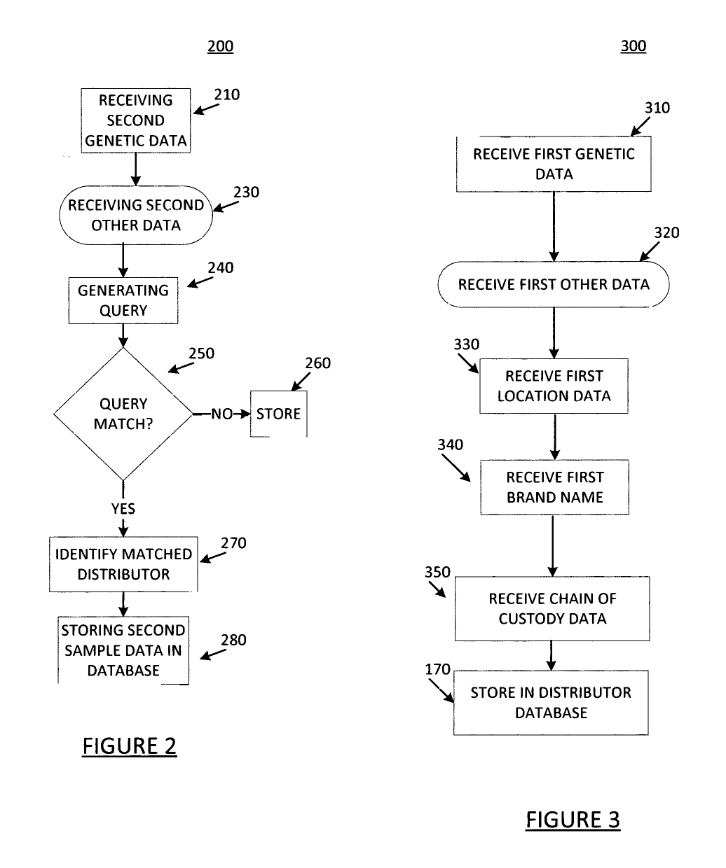

FIG. 2 illustrates the workflow for receiving a second genetic data 210, receiving second other data 230, a generated query 240, match 250 and storage 260, 280 of a regulated plant sample in one embodiment of the distributor database 170. The second genetic data 210 is derived from a second sample of the regulated plant (not shown). The second genetic data 210 may be provided by any of a processor, second distributor, commercial store, manufacturing facility, wholesale, government or regulatory entity. Further details about the second genetic data 210 and the provider may be part of the second other data 230. The second genetic data 210 may be received at any time along the chain of custody of any regulated plant form, and from any third party. The third party providing the second genetic data 210 may provide second other data 230 to strengthen the generated query 240 or to provide more data for the distributor database 170 to reference. Briefly, method 200 relates a plant sample's genetic data 210 with any associated other data 230 that is used to generate a query 240 of the distributor database 170. The potential metrics comprising the match can be modified by the database user and is based on meeting the associated genetic data 210 or the second other data 230 with the inquiry. For purposes of clarity, it will be assumed that the genetic data 210 will be used as the data used in the generated query 240 to identify sample that provide a match 270 in the database.

FIG. 2 indicates that the generated query 240 may be used to query the distributor database 170 at block 250 for a matching first genetic data 110, 120, 130. If the results of the query indicate no match (block 260), then the second genetic data 210 and the second other data 220 will be stored in the distributor database 170 without being associated with any of the stored genetic data 110, 120, 130; nor the first other data 140; nor the first location data 150. The second genetic data 210 and the second other data 220 will be available in later queries as an unmatched second regulated plant sample (not shown) under the second genetic data 210 and the second other data 220.

Briefly, the genetic data will be queried 240 against all samples present in the distributor database 170. Scoring and probability indices will generate a list of samples with varying degrees of relatedness and exact matches, along with distributor, location and other data, will be given when found. The query match result 250 will detail the identity of the matched distribution source 270 and the queried sample data will be stored in the distributor database 280.

With a vast landscape of clones with a remarkable variance of genetic provenance, it will not be uncommon to encounter sample queries with no exact matches (block 260) in the distributor database 170. Elements of the described disclosure take this possibility into account and any regulated plant samples that do not provide an exact match will be deposited into the distributor database 260. The ability to trace the unique signature of many clones will have direct implications in the realm of intellectual property application and will be described in greater detail to follow.

FIG. 3 capitulates a method 300 that takes a cannabis or other regulated plant product's first genetic data 310, first other data 320, and first location data 330 as a source identifier for the branding of said product. In short, method 300 combines first genetic data 310, first other data 320 and first location data 330 to that of a product brand 340. Since the validity of a brand is contingent upon product source identification, the elements of method 300 have been implemented to also store a chain of custody 350 in the distributor database 170 to satisfy these requirements. The chain of custody provided 350 may be provided by any of the processor, second distributor, commercial store, manufacturing facility, wholesale, government or regulatory entity (See FIG. 6) to show under what terms the sample of regulated plant was provided to the processor, second distributor, commercial store, manufacturing facility, wholesale, government or regulatory entity. For example, a distributor may provide a sample of cannabis to a wholesaler or a processor under the terms that the wholesaler or processor does not reproduce or grow their own “clones” of the provided cannabis. By providing method 300, the distributor database will allow an owner-in-interest of a new cannabis strain an opportunity to record with unique detail their strain (first genetic data 310), provide the location wherein the strain was created (first location data 330), and provide other characteristics of the new strain (first other data 320) under an assigned first brand name (block 340). Further, by recording the chain of custody (block 350) the owner-in-interest would be able to uses method 400 (to be discussed below) to query the distributor database 170 and find misappropriation of their strain.

The immutable nature of the genetic data coupled to detailed product transfer metrics will create a chain of custody that can create a defensible line of product protection that is currently unavailable in the industry. For example, a clone may be of particular interest because of certain physical characteristic including, but not limited to, cannabinoid ratio and/or type, chemotype, flavonoid profile, flower aesthetics and other desirable traits determined by producer and consumer alike. Clones may be bred and developed at an original manufacturer/distributor to suit these desires and clones may be sold as viable cultivars, capable of future reproduction/cloning. It is in the original manufacturer/distributor's commercial interest to prevent secondary producers from reselling the clone under a new retail name without granting necessary rights to the original manufacturer. Indeed, the research, trial and error and labor invested into the creation of a popular clone is worthy of protection. The only clear route to protect a cannabis clone's intellectual production is through appropriate source identification and record keeping. Currently, there is no viable method for creating a detailed chain of custody capable of accurately identifying the original manufacturer of a clone. The presented disclosure contains elements, highlighted by creation of a detailed chain of custody 350 that is comprised by a clone's genetic, location and other data.

The presented method will satisfy the needs of future industrial and research applications of cannabis/hemp by specifically chronicling the unique genetic differences inherent to each clone, allowing genomic access for academia, grant manufacturers the capability to trademark clones and establish subsequent intellectual property claims for their unique creations.

FIG. 3 is only one embodiment of the branding method 300. In other embodiments the third genetic data 120 and fourth genetic data 130 may provide a third brand and a fourth brand (not shown). Further, the third genetic data 120 and fourth genetic data 130 may provide a third chain of custody and the fourth chain of custody (not shown).

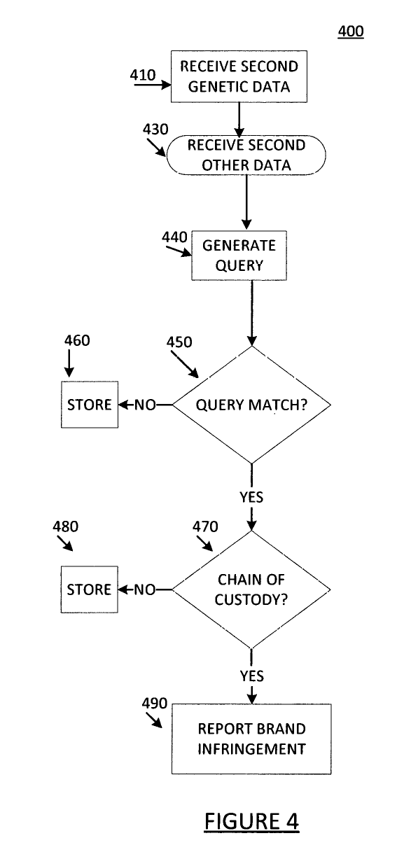

The ability to create a chain of custody for the purposes of product branding have been described, but the ability to track, identify and report brand infringement is central to a self-regulating industry. FIG. 4 shows embodiment of Method 400, a methodology to enforce the intellectual property rights to a source distributor, provides the necessary legal framework to protect a clone's production. Detection of brand infringement relies upon a clone's accession to the distributor database along with detailed chain of custody documentation. In short, genetic data 410 and other data 430 data are parameter used to generate a query 440 that results in a Match/No Match result 450. If an exact match is produced on the genetic data 410, further scrutiny is lent to ascertain whether the unknown sample is infringing upon an established brand. This is done by comparing the known, direct match's chain of custody information with that of the unknown sample. The unknown sample can be determined to be in infringement with the original clone distributor by lack of chain of custody information present in the original accession to the database (block 470). The elements of the invention are equipped to handle point of sale information, along with non-compete agreements, between an original producer and secondary distributor, clearly demarcating and identifying the source production. Brand infringement can only be reported if there is a discrete chain of custody match (block 470) associated with the original accession, otherwise the secondary distributor/third party can freely sell the clone without legal repercussion 480. Chain of custody information may include, but not be limited to parental clones used for breeding, genetic data, chemotype, location and other data.

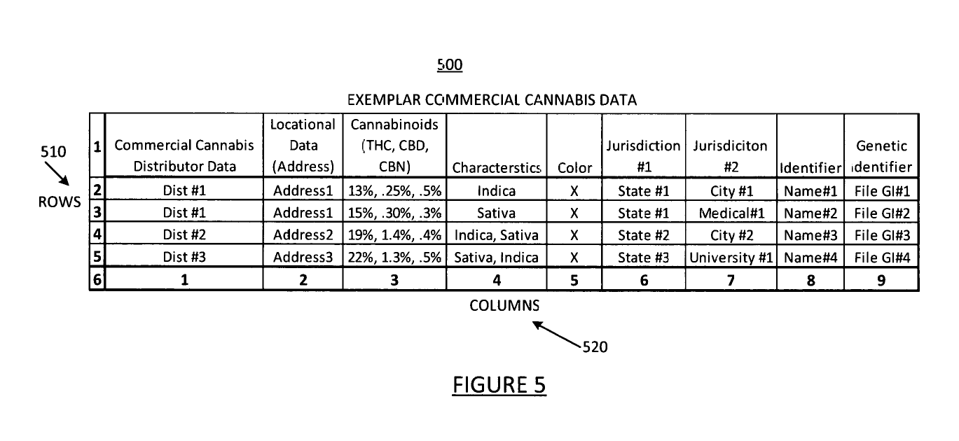

FIG. 5 is a data table 500 that is exemplar of the data stored in the system 600 of FIG. 6. Table 500 is an embodiment showing how samples and their identifiers are presented from the distributor database. Columns 520 show exemplar categories for genetic data 110, 120, 130 other data 140, location data 150; for example genetic identifiers (GI), location, jurisdictional, clone nomenclature, physical characteristics and cannabinoid profile. Rows 510 show an exemplar embodiment of how the processor, second distributor, commercial store, manufacturing facility, wholesale, government or regulatory entity may be related to the various data sets contained in columns 520. Though only distributors are shown in table 500 in other embodiments there may be the processor, second distributor, commercial store, manufacturing facility, wholesale, government or regulatory entities listed as related to the data in table 500.

Turning to FIG. 6, system 600 may be a supply chain that spans several jurisdictions geographically such as a potatoes supply chain. For example the potatoes are grown under a first geographic jurisdiction (e.g., the state of Idaho), and a second safety jurisdiction (e.g., the FDA); then the potatoes are shipped from the first jurisdiction to a process plant in a second geographic jurisdiction that is regulated under a second standard setting jurisdiction. Then the potatoes are shipped to a grocery store where they are regulated by yet a third geographic jurisdiction and a third standard setting jurisdiction.

In this first example, the potatoes transfer from jurisdiction to jurisdiction the original grower (referred to as a “distributor” in this disclosure) will never change for certain potatoes, and the genetic data within those potatoes will never change for certain potatoes. One advantage of this invention that two of the constant, inherent attributes of a regulated plant are utilized to create a universal, unchanging management system that cannot be circumvented and will provide crucial data throughout the life of a regulated plant.

According to FIG. 6, system 600 is comprised of a plurality of distributors or sellers 610 (“distributors” 610), manufacturers or processors 620 (“processors” 620), jurisdictional regulators 640 (“regulators” 640), and third party consumers or resellers 630 (“third parties” 630). In system 600, an exemplar chain of custody may be created by the following (chain of custody not shown in FIG. 6): the distributor 610 provides the regulated plant to a processor 620 under a first geographic jurisdiction of the regulators 640. After processing, third party 630 may obtain the regulated plant and either resell it or consume it. In other embodiments of system 600 there may be dozens or hundreds of each entity. For example in the cannabis industry where cannabis I commercialized there can be dozens of distributors 610 supplying cannabis to dozens of processors 620, who in turn provide the processed cannabis to thousands of third parties 630. As the cannabis is transferred between parties and over many geographic miles throughout the described chain of custody it may be under the regulation of dozens of jurisdictions. For example while the cannabis is being produced it may under the jurisdiction of the state laws where it is being produced, and federal health laws governing the commercial production of consumables. Further, the cannabis may be produced for medicinal reasons at a university. In this example the production of the cannabis would be under the state jurisdiction, under the jurisdiction of a federal oversight body, and under the jurisdiction of the university. It is apparent that a regulated plant may be under dozens of jurisdictions that all depend on the distributor 610, the processor 620, and the third party 630, and the regulator 640 who oversees the various jurisdictions. The current disclosure may be applied to any number of regulators 640, any number of distributors 610, processors 620 or third parties 630 without losing utility or novelty.

In fact as the complexity of the chain of custody, and the number of distributors 610, processors 620, third parties 630, and regulators 640 increase this disclosure provides greater value. On advantage is that the genetics of any regulated plant may be used as an immutable identifier for the regulated plant no matter the jurisdiction or the location. By using the genetic data, this disclosure provides a great value for identifying misused regulated plants, stolen or misappropriated regulated plants, or danger regulated plants and can be used to trace the regulated plant back to the distributor and the jurisdiction wherein it was created. Any of the parties along the chain of custody of a regulated plant, for example distributors 610, processors 620, third parties 630, and regulators 640, may provide genetic data 110, 120, 130; other data 140, or location data 150 to the distributor database 170. This disclosure is not limited in that regard.

In FIG. 6, system 600 is exemplar of the potential sources of regulated plant samples, and the regulators or jurisdictions that are associated with the production of the regulated plants. For example, distributor 610 may grow a new strain of cannabis under a jurisdiction overseen by regulator 640. The cannabis grown by distributor 610 will have an inherent and unique genetic code. A genetic code holds the unique chemical building blocks for an organic entity. Any consumable plant will have a genetic code and therein lies the great value of the current invention. A larger discussion of genetics will be provide below. For system 600 we will discuss the genetic code as an existing identifier unique to the particular cannabis produced by distributor 610.

After distributor 610 has produced the cannabis plant they may provide a sample of the cannabis for genetic sequencing. The genetic sequencing will provide the genetic data used to uniquely identify the cannabis produced by distributor 610. Distributor 610 may provide the genetic data to the distributor database 160 of system 600. The distributor database 170 is a computer implemented data storage module that is accessible over a communications network. To be clear, phrases and terms similar to “network” may include one or more data links that enable the transport of electronic data between computer systems and/or modules. When information is transferred or provided over a network or another communications connection (either hardwired, wireless, or a combination of hardwired or wireless) to a computer, server, repository, or database, wherein the computer uses that connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

In addition to the genetic data provided by distributor 610, the distributor database 170 may also store locational information, jurisdictional information, other cannabis data, and other distributor 610 data. Distributor database 170 may be populated by the distributor 610 over a communications network, or the distributor 610 may provide information to an agent that inputs the data.

Further, processor 620, third party 630, or regulator 640 may provide genetic data to distributor database 170. When processor 620, third party 630 or regulator 640 provides genetic data to the distributor database 170 the locational, other plant data, and identifier data associated with each party may be stored in the distributor database 170. The distributor database 170 may act as a record of the chain of custody (not shown in FIG. 6) because for a particular regulate plant (e.g., cannabis) the genetic data will remain constant. Consequently if the processor 620, the third party 630 or the regulator 640 were to provide genetic data that a distributor 610 has already submitted to the distributor database 610 the genetic data will match and the submitted information will be mapped in the database. More on the genetic data mapping within the distributor database 610 below.

The distributor database 170 of system 600 may hold dozens, hundreds, thousands, or millions genetic data sets tied to location data, jurisdiction data, other regulated plant data, and distributor data. By centralizing the location of production, the chain of custody, the jurisdictional crossing, and other data (e.g., traits, uses, brands, contaminants, etc.) that will be discussed in more detail below; a very valuable tool may be provided across jurisdictions. For example, if cannabis produced legally in a jurisdiction where commercial cannabis is legal and the distributor information and genetic data are stored in distributor database 170 the ultimate use of the cannabis may be identified and misuse halted. Further, in one embodiment, if a sample of cannabis if found in a jurisdiction where cannabis is illegal, a the genetic data may be provided for that illegally found sample and matched against the distributor in a jurisdiction where cannabis is legal. In this case the distributor can be notified that their cannabis is being transferred to an illegally to new jurisdiction so the distributor may take measures to circumvent the illegal use; or law enforcement may use the illegally found cannabis to monitor the distributor who produced the cannabis.

Additionally, if cannabis is being produced for medicinal uses by a university and is found being sold as a commercial and recreational drug, the genetic data will identify the original producer and the producer may be put on notice that the cannabis is being misused. Because of the absolute and unique nature of the genetic data there is no need for an additive or a tracing “tag” to be put on the cannabis. There is great value in this utility.

Referencing FIG. 6, system 600 further comprises a query input module 650. The input module may be any network capable device such as mobile device, computing device, or networked device, including but not limited to phones such as cellular phones (e.g., an iPhone®, Android®, Blackberry®, or any ‘smart phone’), a personal computer, tablet computer, wearable watch, Android® device, iPad®, Google® Glasses, server computer, laptop computer, personal digital assistants, and roaming devices, such as a network-connected roaming device, a wireless device such as a wireless email device or other device capable of communicating wireless with a computer network or server, or any other type of network device that may communicate over a network and handle electronic transactions. Any discussion of any mobile device mentioned may also apply to other devices. All of these devices may serve as the input module 650.

The input module 650 facilitates the querying of the distributor database 170. Input module 650 may receive genetic data, distributor data, other plant data, locational data, branding data, jurisdictional data, or any other information associated with regulated plants. The input module will query distributor database 170 for matches or mapping consistencies within the genetic data (or other corresponding data as previously listed) in order to identify information associated with genetic data from a sample. In some examples an unknown sample of a regulated plant may be identified by querying the genetic data and finding a match within the distributor database of a stored genetic data. In another example a sample of cannabis seized in an illegal transaction may provide genetic data that is inputted into the input module 650. Another advantage of the current invention is that such a minor sample is needed to achieve the genetic data used to query distributor database 170. Unlike prior inventions that require RFID or other “tags” that may easily be removed or manipulated by criminals, hiding the original information related to that regulated plant forever.

After a query is input into input module 650 a query results 660 will be produced. The query results 660 may be raw data or specific mapping matches between the genetic data (or other data) input into input module 650. In other embodiments the query results 660 may be sent to another agent over the communication network for further analysis. In another embodiment the query result may be a code or a rating indicating whether there was a match or successful matching. The query result 660 may identify distributor 610, regulators 640, third party 630 or processor 620. The query result 660 may be a selectable output set by the individual using the input module 650 wherein any regulated plant information may be requested. For example, if genetic data of a cannabis plant is input into input module 650 the query result 660 may be set to return all jurisdictions that the cannabis had been reported, or the uses for that sample, or the original distributor. The query result 660 may provide any information that is stored in the distributor database 170.

The report results 660 are a presentable or transferrable prediction or interpretation of the query results 660.

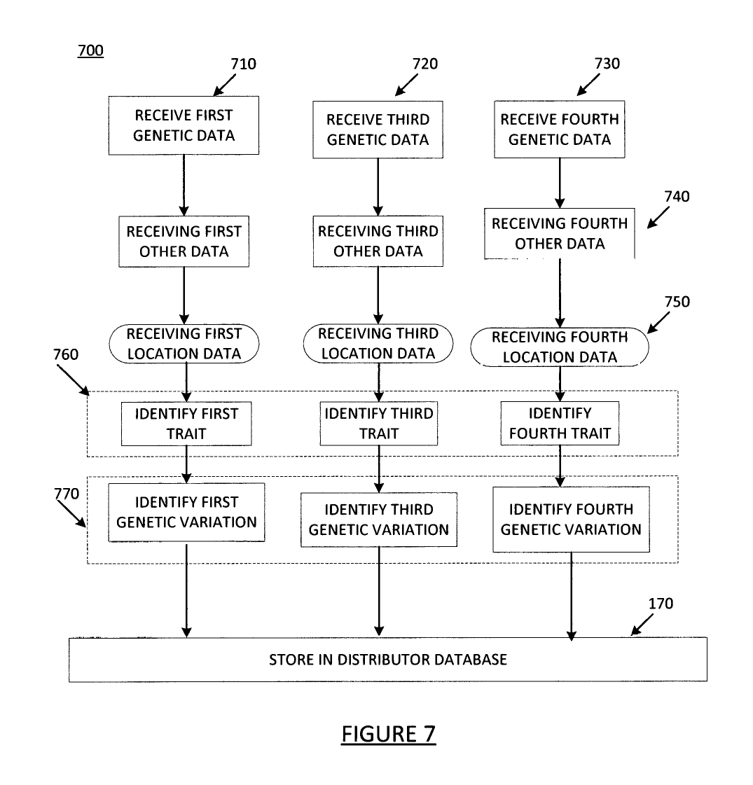

In addition to protecting brand rights and other lines of intellectual property for primary producers/manufacturers, this disclosure offers the industry unprecedented insight into the biology of regulated plant products. FIG. 7 describes method 700, a novel methodology for relating plant phenotype to the genetic data associated with a sample. The illustration depicts how three cannabis samples (710,720,730) are associated with respective other data 740 and location data 750. Certain plant traits may be found to be generally desirable by consumers and producers alike, and it would be of a general benefit to identify the genetic loci that determine these traits. A plurality of samples and their corresponding traits may be mapped by the described disclosure by relating regulated plant genetic data to objective other data. There is an exorbitant amount of clone traits that are capable of being associated with genetic loci found in the genetic data and it would not be feasible to specifically identify each. But for the purposes of description, it is possible to correlate all physical clone characteristics that have an associated genetic marker. It is even plausible to detect traits born of epigenetic modifications, such as those resulting from nucleotide base modifications (DNA methylation), protein alteration (histone) and other expression based differences not directly related to the primary genetic sequence. The fact that RNA or transcript expression profiling can be incorporated into other data accounts for potential epigenetic variants that create unique traits.

The traits to be mapped to genetic data are entirely dependent on the user of the database, but may generally be any physical trait described in other data. It is possible to associate very basic clone metrics such as growth rate, nutrient uptake/requirement and yield, as well as more advance identifiers such as cannabinoid yield/ratio, chemotype and other metabolic properties.

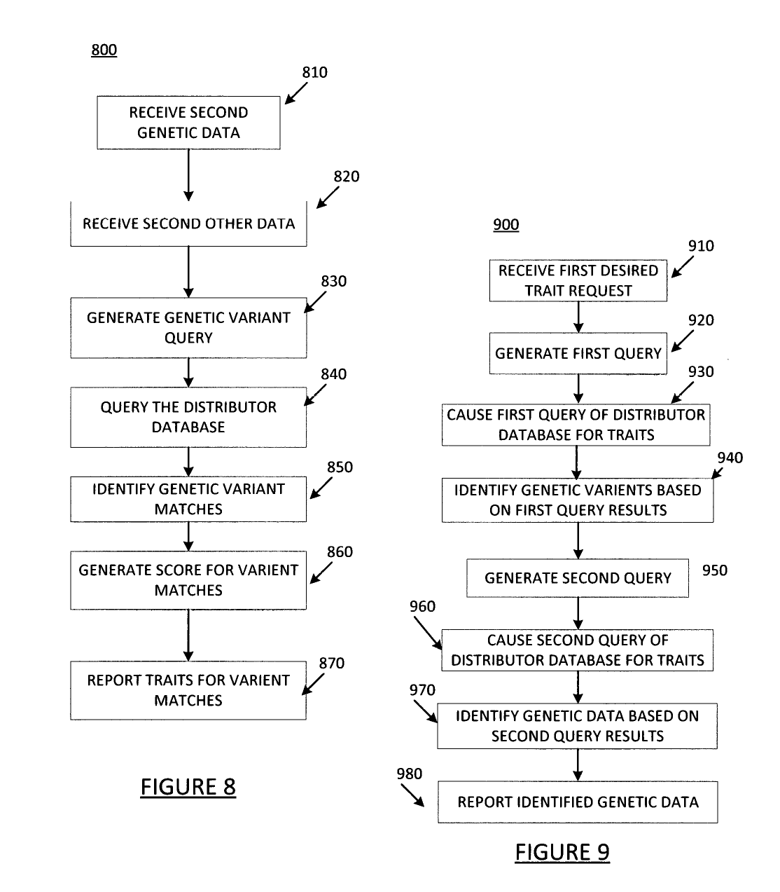

Referring to FIG. 8, the aforementioned ability of the disclosure to map second genetic data 810 and second other information 820 to physical traits can generate provide otherwise unknown physical traits by generating a genetic variant query 830 based on the genetic data 810 (and in other embodiments the genetic variant query is also based on second other data 820), performing a genetic variant query 840 on the distributor database 170. The genetic variant query 840 may identify genetic variant matches (block 850) that were otherwise unknown by the provider of the second genetic data 810, but stored in the distributor database 170 using a method similar to method 700. After genetic variant matches have been identified 850, a score may be generated 860 that predicts the likelihood that the matched genetic variants would be present in the regulated plant that produced the second genetic data 810. A report may be provided 870 to the provider of the second genetic data 810. The report provided in block 870 may be raw genetic data, the score produced in block 860, the generated query in block 830, or a combination of all the data.

For example one genetic variant query 830 of a second genetic data 810 derived from a sample of cannabis may return a genetic variant of a color, and/or a type of growth pattern that matches the second genetic data 810. Additionally second other data 820 associated with the sample of cannabis and provided may be comprised of particular genetic variants that differ from the genetic variant identified from the query 840. For example the second other data 820 may have indicated that the sample of cannabis was a potent, drug-based cannabis and the second other data may have made no mention of the color or the growth patterns. In the case that the second other data 820 does not include the genetic variant identified 850, then the genetic variant 850 may be added to the second other data 820 and associated with the second genetic data 810 in the distributor database 170. Returning to the example, the second genetic data 810 may now be associated with a color and growth pattern in the distributor database 170 creating more second other data 820. Further, the genetic variant query 830 may be any genetic variant described as a first, third, or fourth other data (block 140 of FIG. 1). A finalized report 870 generated from a match score 860 of the query returns all genetic variants sought. Method 800 can serve as an initial search to identify desirable traits possessed by samples in the database, either for relating plants of unknown provenance or for the directed breeding of future clones.

FIG. 9 is an embodiment of method 900 which provides for a query of multiple traits and/or genomic variant held by representative clones in the database. Method 900 relates a plurality of regulated plant sample variants to a plurality of genetic data. The first query 920 is based on a received set of desired traits 910. The desired traits can be trait mentioned above related to growth pattern, potency, industrial use, medicinal use, or consumption.

Once the desired traits 910 are received, the first query 920 will search (block 930) the distributor database 170 for genetic variants stored in the distributor database 170 that match the desired traits 910. The genetic variants identified (block 940) using the first query 920 can be any variant mentioned herein or any variant known in the art. The results from the first query in block 930 will be a plurality of genetic variations (FIG. 7 block 770) that have been stored in the distributor database 170 as being associated with the first desired trait received in block 910. Using the results from the first query 920, a second query is generated 950 based on the identified genetic variants in block 940; and the distributor database 170 is queried using the second query 950 in block 960. Block 960 can include several genetic variants or a single highly desired genetic variant, the disclosure is not limited in this regard.

For example, a cannabis distributor may provide a list of desired traits of cannabis (block 910). A first query may be generated using key words from the desired traits received (block 920). Then the distributor data base 170 is queried using the key words (block 930) based on the desired traits provided by a cannabis distributor. The query of the distributor database may return genetic variant data that was previously stored, (FIG. 7 block 770) and that is associated with the key words describing the desired traits of cannabis. Consequently, the second query would be generated that was based on the genetic variants (FIG. 7, block 770) that were associated with the desired traits. In summary, a distributor provides physical traits of a cannabis plant they wish to grow. Using key words the distributor database is searched for known genetic variants that product the desired physical traits. Then a new query is produced using the genetic variants that were identified.

After the second query in block 960, genetic data can be linked (block 970) to the genetic variants that the query was based on, and that were identified in the distributor database 170. In block 970 the genetic data is identified that can be linked to the desired traits originally received in block 910, and the genetic variants identified during the first query 930. The genetic data identified in the second query 970 is genetic data that is linked to the genetic variants queried in 970. The genetic data is indicative of genetic data 110, 120, 130 of FIG. 1, and may indicate where the regulated plant that shows the desired traits may be located. For example, the genetic data returned (block 970) may be associated with first, third and fourth genetic data (110, 120, 130 from FIG. 1); and consequently related to other data 130 (FIG. 1) and locational data 140 (FIG. 1) providing a source for a type of cannabis that has the first desired traits. A report may generated in block 980 that advises on the genetic data needed, the location data, other data, or sample data to achieve the desired traits received in block 910, and/or the genetic variants identified during the first query 930. The report may be electronic supplied to a distributor, regulatory body, processor, or stored in the distributor database 170 for later reference.

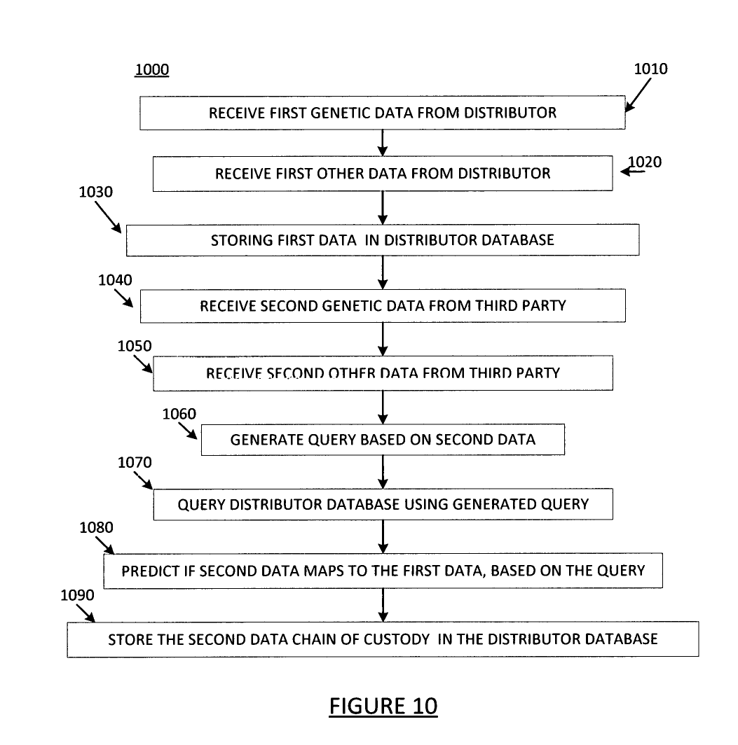

FIG. 10 is another embodiment of the current disclosure. Method 1000 shows how first genetic data received at block 1010, and first other data received at block 1020 may be stored in distributor database 1030 as first data. Further, second genetic data may be received 1040, and second other data may be received 1050. The second genetic data may be provide by any of a processor, commercial store, manufacturing facility, wholesale, government or regulatory entity from any jurisdiction or at any time along the chain of custody of the sample that provided the genetic data. The second cannabis sample and sample data serve as a query (1060 and 1070) that the database then maps to the first data 1080 and subsequently relates and stores the second cannabis sample data to that of the first.

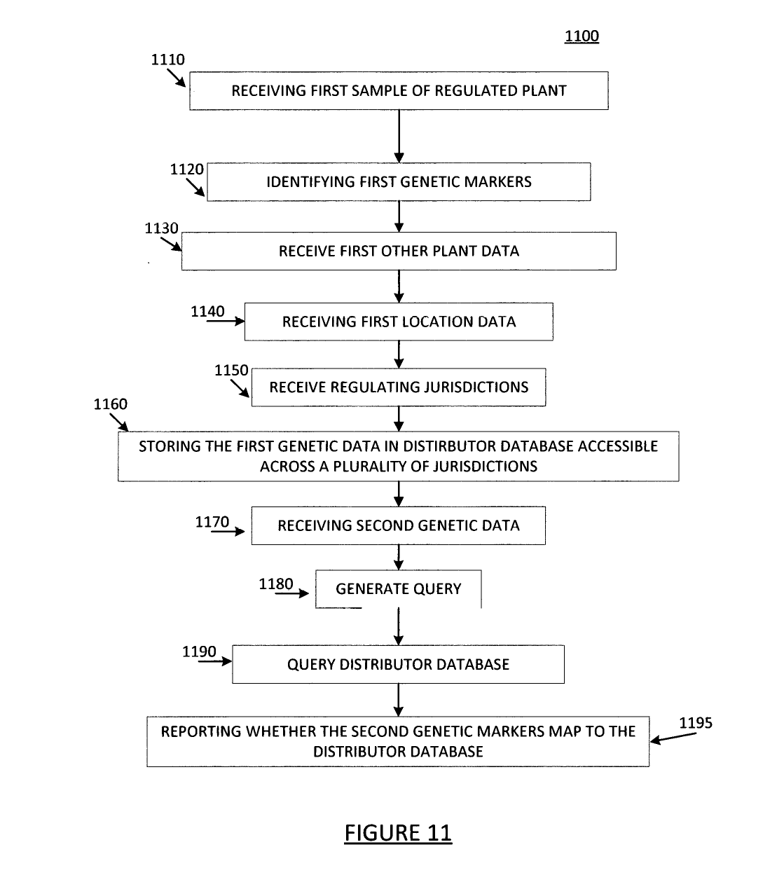

Turning to FIG. 11, method 1100 is exemplar of the data associated with a regulated plant may include the jurisdiction in which the sample was produced, sold or otherwise transferred and the present disclosure makes allowance for this identifier. FIG. 11 captures elements of this embodiment, wherein a regulated plant sample 1110 is associated with a genetic fingerprint 1120, other data 1130, location data 1140 and jurisdictional data 1150. This data may then be made accessible by the distributor database for query 1190 across a plurality of jurisdictions to meet the purposes of legal, commercial, consumer and other regulatory needs. An immediate application of these elements would constitute the tracking of cannabis samples through a complex chain of custody, which may include, but not be limited to, a processor/manufacturer, a number of various distributors, third parties and retail/chain locales. The purposes for tracking are numerous and may be necessary for product recalls, confirmation of label claims, intellectual property/branding/trademark claims, legal investigations and other applications that require source identification.

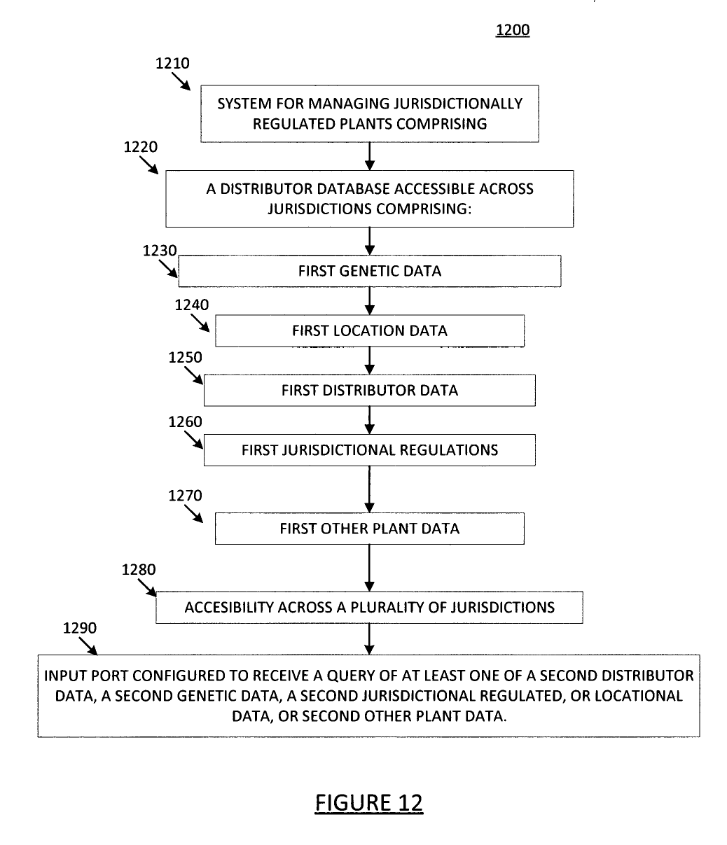

FIG. 12 is an embodiment of a system 1200 of the current disclosure. The system comprises a distributor database 1220 comprising all the data described: first genetic data 1230, first location data 1240, first distributor data 1250, first jurisdictional regulations 1260, first other plant data 1270; wherein the database is accessible across a plurality of jurisdictions as described above. System 1200 provides a user interface or a submission module wherein queries can be received based on any of the first genetic data 1230, first location data 1240, first distributor data 1250, first jurisdictional regulations 1260, or first other plant data 1270.

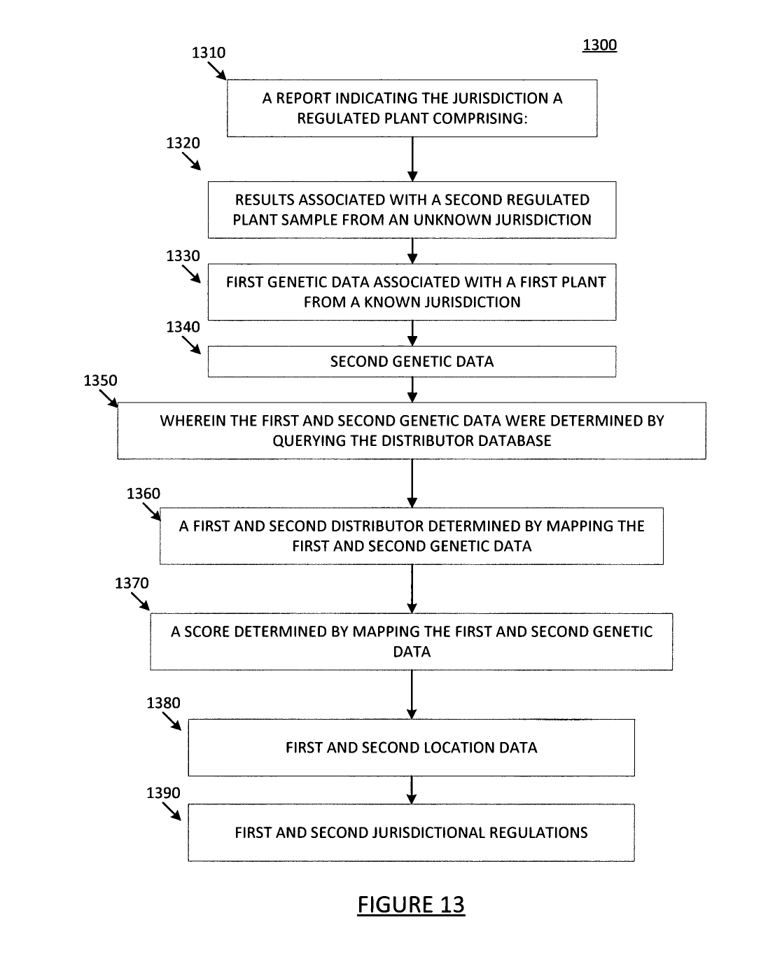

In reference to FIG. 13, system 1300 relates the ability to provide a report that is the product of the system 1200 in FIG. 12. A regulated plant sample of unknown origin may be mapped to the jurisdiction of manufacture in the system 1300 report. The report may be electronic, paper, vocal, or comprised of a collection of correspondence. Generally report from system 1300 is in response to a search request associated with an unknown sample of a regulated plant from an unknown jurisdiction. The report comprises results from querying based on a second regulated plant sample from an unknown or suspicious jurisdiction (block 1320). The results further comprising first genetic data that matched the second genetic data in query (block 1330); second genetic data that was used to base the query (block 1340). The second genetic data may be the only basis for query, or there may be second other data used to create the report 1310. In the report the first and second genetic data are determined by querying the database and mapping the genetic data on to one another 1350. The mapping may be done using known statistical methods, or the report may return a plurality of possible first genetic data matches. In order to further help identify the second regulated plant sample a score may be provided at block 1370 that shows confidence or error in the mapping of the second genetic data onto the first genetic data. Or a plurality of scores related to a plurality of first genetic data.

Further, a first a second distributor may be identified by the first genetic data match. Further, the first genetic data may match a processor, commercial store, manufacturing facility, wholesale, government or regulatory entity depending on the provider of the first genetic data along the chain of custody. Members of the supply and production chain 1360 can be associated with an unknown cannabis sample by mapping and scoring the identifier data 1370 that relates the samples. If a match is determined, then the first and second distributor information, along with their corresponding location 1380 and jurisdictional data 1390. For example, if a sample of cannabis is found in a jurisdiction where cannabis is illegal, the query may match the sample to a distributor in a jurisdiction where cannabis is legal. This match would help limit the legal cannabis being transferred by the identified distributor. Similarly the sample may have come from a medicinal cannabis distributor who is under medical jurisdiction. Again this would help limit the amount of legal medical cannabis being transferred to illegal jurisdictions.

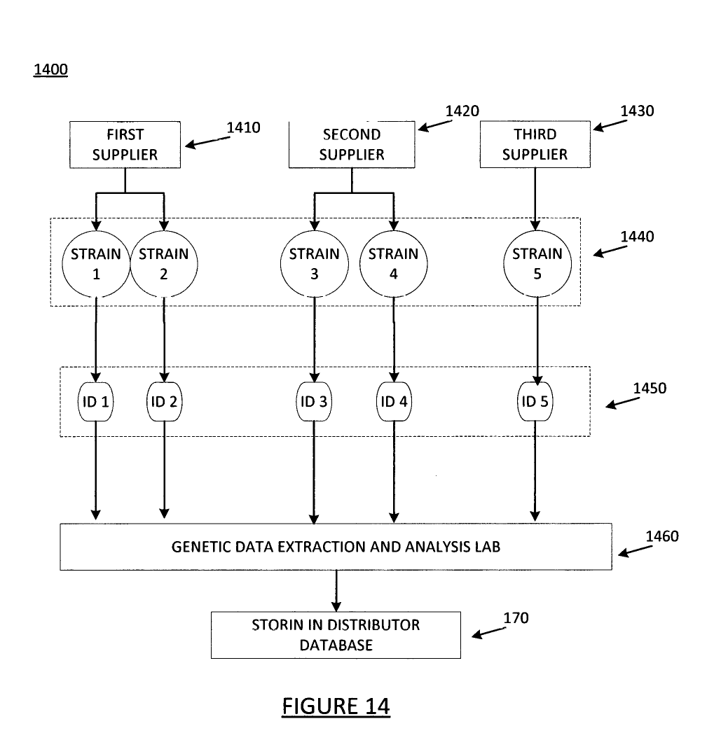

FIG. 14 relates method 1400, a method to store and identify a plurality of cannabis samples 1440 from a multitude of distributors or suppliers (1410, 1420, and 1430). Unique clones are assigned unique ID's 1450 prior to genetic analysis 1460 and deposition into the database 170. All other aforementioned data is then correlated to the unique ID. Unique ID's may be any of a form of ID's found in other industries such as RFID tags.

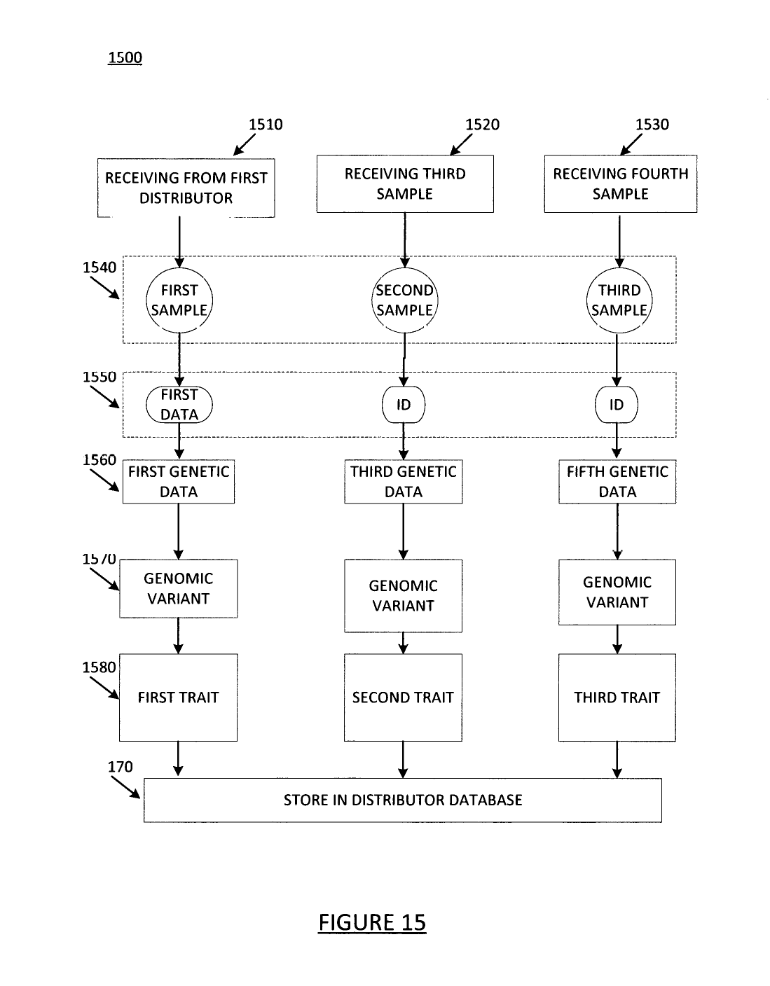

Method 1500 depicted in FIG. 15 illustrates how genomic variants 1570 from a plurality of samples (1510, 1520, and 1530) can be mapped to specific traits 1580. This method is critical to associating clone ID's 1550 and traits 1580 in the distributor database. This concept is central to the creation of marker assisted breeding programs that require the specific mapping and association of traits to individual accessions within the distributor database 170.

Returning to FIGS. 1, 2, 3, 4, 5, 7, 8, 10, 11, and 12, other embodiments of “other plant data” (blocks 140, block 230, block 320, block 430, columns 520, blocks 740, block 820, block 1020 and 1050, block 1130, and block 1270) briefly, other examples of first other data received in blocks 140 are: species, subspecies, varieties; plants cultivated for fiber, seed production, low-intoxicant, non-drug, or fiber types; or plants cultivated for drug production, high-intoxicant, or drug types; or wild forms. The other first data may have transgenetic data indicating the single or multiple genes transferred from a different species of plant and integrated into the regulated plant using techniques such as Agrobacterium Transformation or Agrobacterium tumefaciens; microinjection, color or light dependent, coding markers, bio markers.

Further, “other plant data” in FIGS. 1, 2, 3, 4, 5, 7, 8, 10, 11, and 12, (blocks 140, block 230, block 320, block 430, columns 520, blocks 740, block 820, block 1020 and 1050, block 1130, and block 1270) may indicate backcrossing breeding, cross-pollination breeding, Desired Agronomic Characteristics; Agronomic characteristics (which will vary from crop to crop and plant to plant) such as yield, maturity, and fluorescence percent which are desired in a commercially acceptable crop or plant. For example, improved agronomic characteristics for Cannabis include THC yield, maturity, flower, bud, seed qualities. The first other data may include donor parent data, or essentially all the physiological and morphological characteristics. A plant having essentially all the physiological and morphological characteristics means a plant having the physiological and morphological characteristics, except for the characteristics derived from the desired trait. Or fruiting nodes: the number of nodes on the main stem from which arise branches that bear fruit or boll in the first position. Further the first other data may be the genotype (the genetic constitution of a cell or organism); haploid data (cell or organism having one set of the two sets of chromosomes in a diploid); linkage data (a phenomenon wherein alleles on the same chromosome tend to segregate together more often than expected by chance if their transmission was independent); maturity rating (a visual rating near harvest on the amount of buds, seeds on the plant); phenotype (the detectable characteristics of a cell or organism, which characteristics are the manifestation of gene expression); plant data (includes a mature plant, immature plant, seedling, seed or cutting, cell, plant tissue or anything that can be directly planted, or planted after vegetative growth such as in tissue culture, to produce a mature plant); Quantitative Trait Loci (QTL) (Quantitative trait loci (QTL) refer to genetic loci that control to some degree numerically representable traits that are usually continuously distributed); recurrent parent (the repeating parent (variety) in a backcross breeding program. The recurrent parent is the variety into which a gene or trait is desired to be introduced); seed data (refers to the number of seeds per plant); seedweight (refers to the weight of 100 seeds in grams); self-pollination (the transfer of pollen from the anther to the stigma of the same plant or a plant of the same genotype); Single Locus Converted (Conversion) Plant (plants which are developed by a plant breeding technique called backcrossing wherein essentially all of the desired morphological and physiological characteristics of a variety are recovered in addition to the characteristics conferred by the single locus transferred into the variety via the backcrossing technique. A single locus may comprise one gene, or in the case of transgenic plants, one or more transgenes integrated into the host genome at a single site (locus)); substantially equivalent data (a characteristic that, when compared, does not show a statistically significant difference (e.g., p=0.05) from the mean); tissue culture data (a composition comprising isolated cells of the same or a different type or a collection of such cells organized into parts of a plant).

Further, FIGS. 1, 2, 3, 4, 5, 7, 8, 10, 11, and 12, may have embodiments wherein “other plant data” (blocks 140, block 230, block 320, block 430, columns 520, blocks 740, block 820, block 1020 and 1050, block 1130, and block 1270) may comprise transgene data (a genetic locus comprising a sequence which has been introduced into the genome of a Cannabis plant by transformation); vegetative nodes data (the number of nodes from the cotyledonary node to the first fruiting branch on the main stem of the plant), wild type cannabis (cannabis plants that are not transgenically modified with a bio-marker, including such plants cultivated and/or bred to provide illicit THC, cannabis and marijuana can be used interchangeably, cannabis has levels of ⁹-tetrahydrocannabinol. THC a psychoactive molecule that produces the “high” associated with marijuana. The psychoactive product consists of dried flowers and leaves of plants selected to produce high levels of THC). Cannabis is an annual, dioecious, flowering herb. The leaves are palmately compound or digitate, with serrate leaflets. The first pair of leaves usually have a single leaflet, the number gradually increasing up to a maximum of about thirteen leaflets per leaf (usually seven or nine), depending on variety and growing conditions. At the top of a flowering plant, this number again diminishes to a single leaflet per leaf. The lower leaf pairs usually occur in an opposite leaf arrangement and the upper leaf pairs in an alternate arrangement on the main stem of a mature plant. Cannabis normally has imperfect flowers, with staminate “male” and pistillate “female” flowers occurring on separate plants. All known strains of cannabis are wind-pollinated and produce “seeds” that are technically called achenes. Most strains of cannabis are short day plants with the possible exception of C. sativa subsp. satliva var. spontanea (C. ruderalis). Cannabis, like many organisms, is diploid, having a chromosome complement of 2n=20. Other first other data can be recognized in the art. One such description is described in US Patent Pub. 2012/0311744, “Marked Cannabis For Indicating Medical Marijuana,” published Dec. 2, 2012 from Erich E. Sirkowski, which is incorporated herein by reference in its entirety.

Cannabis Embodiment Generally

The legal cannabis industry operates under a general set of principles that vary slightly state by state according to the specific policies and enabling legislation of the respective state. There are also three different market segments in the cannabis industry, not all of which are allowed by individual state laws. These market segments are: medical use, adult recreational use and industrial hemp. However, there are general similarities common to all states. In all market segments and states, cannabis breeding and growing is performed by producers and regulated sales to consumers are performed by distributors. In some cases, the producer and distributor may be the same entity, but because of the variation in how these roles are regulated across the different states, we maintain this distinction for conceptual and descriptive clarity. In most cases, the various market segments are regulated using the producer/distributor distinction, even in those cases where different government departments have oversight over various segments. Where not otherwise specified, our claims and preferred embodiments apply to all market segments.

The presented disclosure adds value to the cannabis industry by implementing a means of tracking the movement of cannabis at all points in the product lifecycle, even post sale in the case of providing accountability for consumer complaints and of the seizure of cannabis suspected to be of illegal origin or illegally diverted from legitimate producers and/or distributors.

Many types of regulatory agencies perform three major work functions that are the essence of governmental regulation in most fields: requirement setting, compliance monitoring, and enforcement. The description of the preferred embodiment will refer primarily to cannabis and regulated plants, which is particularly complex due to the pollution control technologies involved and the multitude of laws, rules and jurisdictions. However, the data management problems addressed by the present invention are not confined to cannabis and other regulated plants.

The cannabis genome is a direct chemical blueprint that encodes the cellular machinery necessary to support the life of the cannabis plant. Modern understanding of genomics has revolutionized evolutionary biology and created new divisions of modern genetics such as functional genomics, systems biology, molecular ecology and synthetic biology. This expansive increase in knowledge and practice was made possible by affording those familiar with the art the ability to make direct comparisons of biological life forms based on functional annotations of genetic data from other organisms. This contrasts with the centuries old practice of subjective classification based on highly variable morphological data. While this practice can be effective for producing crop improvements, it is not always efficient in terms of time and capital investment when better methods are available. This disclosure adds value to the cannabis industry by applying these functional annotations to the practical purpose of guiding efficient breeding programs for crop improvement.

The evolutionary relationship between organisms is typically expressed in terms of a genetic distance and quantifies relatedness by the innate and absolute genomic variations produced from assorted pressures and processes, whether of natural or artificial influence. The expression of these genetic distances as a dendrogram helped refine and establish the currently recognized Universal Tree of Life and Biological Species Concept, allowing comparisons to be made on taxonomic scales ranging from Domain to intra-species.

Examination of genetic data of cannabis through progressively advanced techniques relating biochemistry, developmental biology and functional genomics has led to a deeper understanding of how cannabis genotypes lead to cannabis phenotypes, while exploitation of genomics as a historical archive may allow significant evolutionary inferences to be made with respect to diversity within populations and divergence between cannabis clones.

The present embodiment employs the accuracy and specificity of DNA sequencing technology and associated molecular biology techniques to establish a system configured to store the degree of relation, or genetic distance, for cannabis clones. The system may allow various entities such as law enforcement, regulatory authorities, producers and distributors, intellectual property claimants, health professionals and industrial and academic researchers to obtain and validate information about various clone genotypes. The information may be utilized in order to indict or absolve parties suspected of diversion, provide a means to associate clone genotype to phenotypic/chemical profiles for regulatory and intellectual property requirements, identify and select for desirable traits for novel clone production/crop improvement and to promote a universal system capable of validating and incorporating current databases.

As previously described, the new cannabis industry will be improved with a high throughput genotyping system capable of irrefutably differentiating distinct, but highly similar cannabis clones for multiple industrial and societal interests. The only currently offered cannabis genotyping technology for identification, offered by ACTG Inc., relies on a methodology that identifies short tandem repeat (STR) and is exclusively used for forensic analysis of non cannabis. Although suitable for this single purpose, the inability of this method to capture raw nucleotide sequence data on a scale needed by the cannabis industry reduces the scope of future investigations into other genomic loci and limits the ability to characterize highly related cannabis clones for a dynamic new industry that requires higher information quality for future applications and interests beyond forensic analysis.

The current disclosure will afford appropriate authorities and producers a greater amount of cannabis allelic data, in the form of a greater number of polymorphisms analyzed, in the same or a lesser amount of time as current methods, allowing unparalleled insight into the functional genomics of cannabis. This insight will allow quick and irrefutable evidence needed to meet the cannabis's industrial needs set forth by the present disclosure.

An immediate application of a database composed of physical cannabis samples, extracted DNA and the associated electronic records is that of establishing priority and ownership over clones in the absence of Federal sanction of plant patents, utility patents and trademarks on cannabis clones and cannabis products. In the established horticultural industry, for example, developers of novel plant clones can secure patents that protect their right to royalties. The rationale for this system is that such property rights create the incentives for growers to invest the time and resources needed to develop useful new clones. In the absence of these rights, it will be difficult for cannabis growers to justify the risk and expense of developing better clones for the multitude of applications of cannabis we have referred to in this application. Without secure intellectual property rights, a competitor can easily obtain a small amount of living material, create a viable clone therefrom and profit from it without the inventor of the clone having recourse to claim the royalties that would otherwise be their due in any other crop plant. This disclosure will allow the development of state level registries to encourage development of beneficial clones for all the market segments. Once infringement of trademark is suspected, the data may be used to pursue legal remedies should infringement be detected. The date upon which a sample was entered into the database will be used in any legal action as evidence of priority and ownership of an original clone.

The high throughput sequencing approach will create a cannabis genotype profile coupled to a universal database capable of storing industrially significant data of multiple cannabis types and will offer unprecedented quality of information to be used for numerous purposes previously mentioned. The presented disclosure will utilize a database and an associated cannabis sample storage system that will be accessed using software for analysis by those familiar with the art.

The presented disclosure will consist of a cannabis genotyping method coupled to a database that holds the cannabis genetic data, in the form of raw DNA sequence reads, for future analyses as needed by appropriate authorities and entities. Applications in the legal and regulatory arena will require differing levels of genotype data and the flexibility of the presented disclosure will suit these requirements. The massive amount of cannabis genomic content derived by the disclosed system and method will allow the unique ability to infer functional annotations of cannabis clone genotypes with the intention of establishing a breeding program guided by these correlations. Data compiled by the disclosed system is to be stored in the aforementioned database and will be used for diversion and intelligence purposes to track distribution patterns, source of manufacture, implement quality control practices and allow informative data for intellectual property claims and establishment of marker assisted breeding programs for cannabis.

Past genotyping methods such as STR, AFLP, RFLP, and other gene analyses, may be assimilated into the disclosed database, as the disclosed system offers direct DNA sequence as the fundamental unit of analysis. This is a unique attribute of the presented disclosure and permits the assimilation and confirmation of existing cannabis genomic databases obtained from menial methods.

The disclosed system can be further enhanced through integration with information management technology such as web based reporting and documentation, association of quality controllquality assurance profiles to cannabis farm/clones and traceability tracking software. Cannabis clone sample information such as, but not limited to, sample date, clone name, producer/farm of origin, location(s) distributed, sample shipping and storage may be stored in the database. The cannabis genotype information may be received from those well known to the art via file uploads or database links. The raw cannabis sequence reads will each be extracted in data types, such as FASTA, or other data types known to those familiar with the art and will be subsequently subjected to data analysis programs. Calculation of genetic distances and clonal relationships will be displayed in formats amenable to the purposes of various inquiries and each genotype recorded will be stored for future analyses and comparisons. Correlation of cannabis plant phenotype to genotype data will be stored and analyzed for creation of Marker Assisted Breeding Programs.

For the purposes of this disclosure, a distributor shall be defined as a commercial entity actively offering cannabis samples; more specifically any commercially handler of cannabis all the way down to the consumers, such as a licensed retail dispensary, processor, commercial store, manufacturing facility, wholesale, government or regulatory entity. The identifier for a cannabis sample from a plurality of distributors may include, but is not limited to, clone nomenclature, date, time, quantity sampled, tissue type, region of clone sampled, chemical profile, quality assurance/control data, chain of custody documentation, producer and distributor. Physical samples will be associated with electronic records via human or machine readable labels with a unique identifier per sample and will be uploaded by means to those familiar with the art, such as a database link. Physical samples will be stored using a combination of room temperature and low temperature storage media. Original samples will be stored in multiple media to achieve sample security through redundancy to assure that usable sample material survives for subsequent re-analysis as circumstances warrant.

Due to the variety of analytical methods in use, the process for determining a cutoff score will vary, but the general principle will remain the same across all analytical methods. For a chosen technique, there will be a preferred method for choosing a statistical cutoff. The processor will be have a customized cutoff for determining identity for each analytical technique according to the state of the art for that technique.

The present disclosure provides a number of benefits and advantages. These include a greater capacity to meet current and future regulatory and legal requirements, improvement of the cannabis industry's image, obtaining credibility via establishment of industrial transparency for the purposes of diversion prevention and consumer safety, reliable guarantee of cannabis origin, verification of claims of a producer for example, organic, novelty of a cannabis clone and enhanced cannabis product value due to the presence of specific gene variants (as demonstrated with genetic markers) that can only be truly known through exact knowledge of the nucleotide sequence of many genomic loci.

A preferred embodiment of this method will be the generation of assays using oligonucleotides on solid surfaces for purposes including, but not limited to, rapid genomic locus detection, in a cannabis sample. Information taught through the implementation of this disclosure will be used for future applications in the cannabis industry still yet to be determined.

In conclusion, the present disclosure is configured to relate expressing the relatedness of two or more cannabis clones to provide informational transparency from seed to sale and beyond. Furthermore, the disclosed system can discretely associate genotype, gathered from potentially hundreds of thousands of genomic loci, with a cannabis plants phenotype, or expressed cannabis botanical characteristics. Performing such objectives is taught by this disclosure via a high throughput and high information quality method that is able to distinguish, unequivocally, the relationship and novelty of analyzed cannabis clones for the purposes of regulatory implementation, consumer safety, crop improvement, clone trademarking and industrial credibility.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents. For example, although the above discloses example sources of regulated plant samples including, among others processors, commercial wholesale, distributors, third parties; it should be noted that such examples are merely illustrative and should not be considered as limiting.

What is claimed is:

1. A non-transitory computer readable medium that stores instructions for mapping identifying genetic data of cannabis to data stored in a distributor database, the distributor database comprising a plurality of identifying genetic data, location data, and other cannabis data, the instructions being executable by one or more processors from one or more computer network locations to perform the steps of:
receiving first identifying genetic data from a first sample of cannabis; wherein
the first sample of cannabis was provided by a first distributor,
receiving first other cannabis data associated with the first sample of cannabis;
receiving first location data associated with the first distributor;
receiving a second identifying genetic data from a second sample of cannabis; wherein,
the second sample of cannabis is provided by a first third party;
generating a query based on the second identifying genetic data;
searching the distributor database using the query;
receiving one or more results from the search;
using the one or more results to determine whether a match is indicated between the second identifying genetic data and the first identifying genetic data; wherein
a match of the second identifying genetic data to the first identifying genetic data further indicates a match between the second sample of cannabis to the first sample of cannabis; and
storing the second identifying genetic data in the distributor database based on the results from the query.

2. The non-transitory computer readable medium of claim 1, wherein:
first location data further comprises first jurisdictional data associated with a first regulatory jurisdiction that regulates the commercialization of the first cannabis sample.

3. The non-transitory computer readable medium of claim 1, wherein:
first location data further comprises first jurisdictional data associated with a first regulatory jurisdiction that regulates the commercialization of the first cannabis sample; and
first other cannabis data comprises second jurisdictional data associated with a second jurisdiction that regulates the commercialization of the first cannabis sample.

4. The non-transitory computer readable medium of claim 1, wherein:
first location data further comprises first jurisdictional data associated with a first regulatory jurisdiction that regulates the commercialization of the first cannabis sample;
first location data further comprises the first distributor location where the first distributor produced the first sample of cannabis; and
the distributor location is within the scope of the first regulatory jurisdiction.

5. The non-transitory computer readable medium of claim 1 further comprising:
receiving second other cannabis data associated with the second sample of cannabis;
generating a second query based on the second other cannabis data;
searching the distributor database using the second query;
receiving one or more second results from the second query;
using the second results from the second query to determine if a match exists between the second other cannabis data and the first other cannabis data; and
storing the second other cannabis data in the distributor database based on the second results.

6. The non-transitory computer readable medium of claim 1, wherein:
the first identifying genetic data further comprises genetic data sequenced using one of STR, AFLP, RFLP, and/or other gene sequencing method that offers direct DNA sequence as the fundamental unit of analysis.

7. The non-transitory computer readable medium of claim 1, further comprising:
receiving third identifying genetic data from a third sample of cannabis; wherein
the third sample of cannabis was provided by a third distributor,
receiving third other cannabis data associated with the third sample of cannabis;
receiving third location data associated with the third distributor; wherein the third location data comprises third jurisdictional data associated with a third regulatory jurisdiction that regulates the commercialization of the third cannabis sample; and
using the one or more results further comprises:
using the one or more results to determine a match between the second identifying genetic data and the third identifying genetic data; wherein
a match between the second identifying genetic data and the third identifying genetic data indicates a match between the second sample of cannabis and the third sample of cannabis.

8. The non-transitory computer readable medium of claim 7, wherein:
the first and second cannabis samples are not a match based on the query results;
the second and third cannabis samples are a match based on the query results;
the third distributor is the same distributor as the first; and
the third location data is different than the first location data.

9. The non-transitory computer readable medium of claim 1, wherein:
first other cannabis data further comprises one or more of a plurality of physical attributes of the first cannabis sample, comprising one or more of:
first cannabinoids content, first other physical characteristics, first color, and/or first contaminants, growing conditions, medicinal uses, commercial pricing, special usage instructions, parent cannabis plants, and/or date of inception.

10. The non-transitory computer readable medium of claim 1, wherein:
the first other cannabis data comprises a chain of custody record comprising:
a relationship record between the first distributor and a second third party, an owner-in-interest data record, and a date of first production of the first cannabis sample; wherein,
the relationship record includes restrictive reproduction clauses, certain growers restrictions and trade secret language regarding the first cannabis sample wherein the second identifying genetic data maps onto the first identifying genetic data.

11. The non-transitory computer readable medium of claim 10, wherein:
the first and second third party are different third parties, and
the first third party is misappropriating the branding rights of the first distributor.

12. The non-transitory computer readable medium of claim 1, wherein:
the first distributor may access the distributor database and receive query results associated with chain of custody data of the first identifying genetic data;
the first third party may access the distributor database and receive query results associated with the second identifying genetic data; wherein,
the first third party is one of a manufacturer, processor, wholesale, governmental, regulator, commercial store, or any other third party.

13. A method for mapping identifying genetic data to data stored in a distributor database, the distributor database comprising a plurality of identifying genetic data, plurality of other cannabis data, plurality of location data, a plurality of distributor data, and a plurality of jurisdictional regulations, the method comprising:
receiving first identifying genetic data from a first sample of cannabis; wherein:
at least one or more of a first other cannabis data, a first location data, a first jurisdictional regulations, and/or a first distributor associated with the first sample of cannabis is unknown;
generating a first query based on the first identifying genetic data;
querying the distributor database using the first query;
receiving one or more results from the search;
using the one or more results to determine a matching second identifying genetic data to the first identifying genetic data; wherein
the second identifying genetic data associates at least one of a second other cannabis data, a second location data, a second jurisdictional regulations, and/or a second distributor to the first sample of cannabis when matched.

14. The method of claim 13, wherein:
Using the one or more results to determine a matching second identifying genetic data to the first identifying genetic data further comprises at least one of the following:
predicting a probability that the first sample of cannabis matches a stored second sample of cannabis provided by a second cannabis distributer;
projecting the probability that the first sample of cannabis was from the second jurisdiction;
projecting the probability that the first cannabis sample is associated with a second other cannabis data; and/or
projecting the probability that the first cannabis sample is associated with a second location data.

15. The method of claim 13, wherein:
receiving the first cannabis genetic data from a first sample of cannabis further comprises:
receiving first other cannabis data associated with the first cannabis sample;
generating a query based on the genetic identifying data and a portion of the first other cannabis data.

16. The method of claim 13, wherein:
first other cannabis data further comprises first jurisdictional regulation data associated with the commercialization of the first cannabis sample; and wherein,
using the one or more results to determine a matching second identifying genetic data to the first identifying genetic data further comprises:
matching the second jurisdictional regulation to the first jurisdictional regulations, and
matching a second distributor to a first distributor.

17. The method of claim 13, wherein:
first identifying genetic data further comprises genetic first genetic data sequenced from using one of STR, AFLP, RFLP, and/or other gene sequencing method that offers direct DNA sequence as the fundamental unit of analysis.

18. The method of claim 13, wherein:
a first other cannabis data comprises a chain of custody record, a relationship record, and a date the first cannabis sample was stored, and
the first other cannabis data matches a second other cannabis data;
a first distributor does not match the second distributor.

19. The method claimed in claim 13, wherein:
receiving first identifying genetic data from a first sample of cannabis comprises receiving one of:
a plant, extracted concentrate, oil, or a consumable; and
receiving the first sample of cannabis from a first third party comprising one of: a manufacturer, processor, wholesale, governmental, regulator, commercial store, or any other third party.

20. A non-transitory computer readable medium that stores instructions for mapping cannabis genetic variation data to data stored in a distributor database, the data comprising a plurality of cannabis genetic variants, a plurality of cannabis genetic data, a plurality of cannabis distributors, and a plurality of other cannabis data, the instructions being executable by one or more processors from one or more computer network locations to perform the steps of:
receiving first identifying genetic data from a first sample of cannabis; wherein
the first sample of cannabis was provided by a first cannabis distributor, and the sample of cannabis has first genetic variants and physical traits;
receiving first other cannabis data;
receiving first location data associated with the first cannabis distributor;
receiving a second identifying genetic data from a second cannabis sample; wherein
second genetic variants and physical traits are not received;
generating a first query based on the second cannabis identifying data;
searching the distributor database using the first query;
receiving one or more results from the search;
using the one or more results, determining a match between second identifying genetic data and the first identifying genetic data; wherein
the match further matches the first genetic variants to the second genetic variants, and
the first physical traits to the second physical traits.
storing the second identifying genetic data in the distributor database based on the results; and
providing a report based on the results comprising the first and second identifying genetic data, the first and second genetic variants, and the first and second physical traits.
